(19) United States
(12) Patent Application Publication
(10) Pub. No.: US 2024/0275432 A1
(43) Pub. Date: Aug. 15, 2024

(54) RECIPROCITY FOR PASSIVE MULTIPLE-INPUT MULTIPLE-OUTPUT

(71) Applicant: QUALCOMM Incorporated, San Diego, CA (US)

(72) Inventors: Hung Dinh LY, San Diego, CA (US); Saeid SAHRAEI, San Diego, CA (US); Yu ZHANG, San Diego, CA (US); Krishna Kiran MUKKAVILLI, San Diego, CA (US)

(21) Appl. No.: 18/567,672

(22) PCT Filed: Aug. 27, 2021
(86) PCT No.: PCT/CN2021/115020

§ 371 Date: Dec. 6, 2023

(51) Int. Cl. H04B 7/04

(52) U.S. Cl. CPC H04B 7/04013

(57) ABSTRACT

A passive multiple-input multiple-output (P-MIMO) method that may be performed by a reconfigurable intelligent surface (RIS) includes applying a first voltage set to one or more unit cells of the RIS for reflecting a downlink signal from a first wireless communication device to a second wireless communication device. The method includes applying a second voltage set to the one or more unit cells of the RIS for reflecting an uplink signal from the second wireless communication device to the first wireless communication device.

### BACKGROUND

### Field of the Disclosure

Aspects of the present disclosure relate to wireless communications, and more particularly, to techniques for passive multiple-input multiple-output (P-MIMO).

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few.

These and other multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Certain aspects of the subject matter described in this disclosure can be implemented in a method for wireless communication by a reconfigurable intelligent surface (RIS). The method generally includes applying a first voltage set to one or more unit cells of the RIS for reflecting a downlink signal from a first wireless communication device to a second wireless communication device. The method generally includes applying a second voltage set to the one or more unit cells of the RIS for reflecting an uplink signal from the second wireless communication device to the first wireless communication device.

Certain aspects of the subject matter described in this disclosure can be implemented in a method for wireless communication by a base station (BS). The method generally includes signaling a RIS to apply a first voltage set to one or more unit cells of the RIS for reflecting a downlink signal from the BS to a wireless communication device and apply a second voltage set to the one or more unit cells of the RIS for reflecting an uplink signal from the wireless communication device to the BS.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating aspects of an example base station (BS) and user equipment (UE), in accordance with certain aspects of the present disclosure.

FIGS. 3A-3D depict various example aspects of data structures for a wireless communication network), in accordance with certain aspects of the present disclosure.

FIG. 4 illustrates an example arrangement of reconfigurable intelligent surface (RIS) elements, in accordance with certain aspects of the present disclosure.

FIG. 5 illustrates an example wireless communication environment in which signaling between a BS and a UE is blocked, in accordance with certain aspects of the present disclosure.

FIG. 6 illustrates an example wireless communication environment in which a RIS is used to relay signaling between a BS and a UE to overcome a blockage, in accordance with certain aspects of the present disclosure.

FIG. 7 illustrates a loss of reciprocity in an example wireless communication environment between uplink and downlink signals relayed by a RIS, in accordance with certain aspects of the present disclosure.

FIG. 8 illustrates control information to a RIS in frequency resources non-overlapping with a downlink bandwidth part (BWP), in accordance with certain aspects of the present disclosure.

FIG. 9 illustrates control information to a RIS in frequency resources overlapping with a DL BWP, in accordance with certain aspects of the present disclosure.

FIG. 10 is an example varactor circuit in a RIS, in accordance with certain aspects of the present disclosure.

FIG. 11 is a call flow diagram illustrating example signaling for fixed reciprocity passive multiple-input multiple-output (P-MIMO), in accordance with aspects of the present disclosure.

FIG. 12A-12B is a flow diagram illustrating example operations for wireless communication by a RIS, in accordance with certain aspects of the present disclosure.

FIG. 13A-13B is a flow diagram illustrating example operations for wireless communication by a BS, in accordance with certain aspects of the present disclosure.

FIG. 14 illustrates an example communications device, in accordance with aspects of the present disclosure.

FIG. 15 illustrates an example communications device, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for passive multiple-input multiple-output (P-MIMO).

P-MIMO may employ reconfigurable intelligent surfaces (RIS) to reflect traffic and improve network coverage. For example, RIS may be used to overcome blockages between wireless communication devices by reflecting signals between the wireless communication devices around the blockage. In some cases, however, when a RIS is used, channel reciprocity may not hold between uplink and downlink communications between devices.

Aspects of the present disclosure provide for fixed reciprocity in P-MIMO. In some examples, the angle of reflection of the signal by the RIS can be controlled by applying a voltage set to one or more unit cells of the RIS. Different voltage sets can be applied for uplink than for downlink, in order to provide fixed reciprocity.

### Example Wireless Communication Network

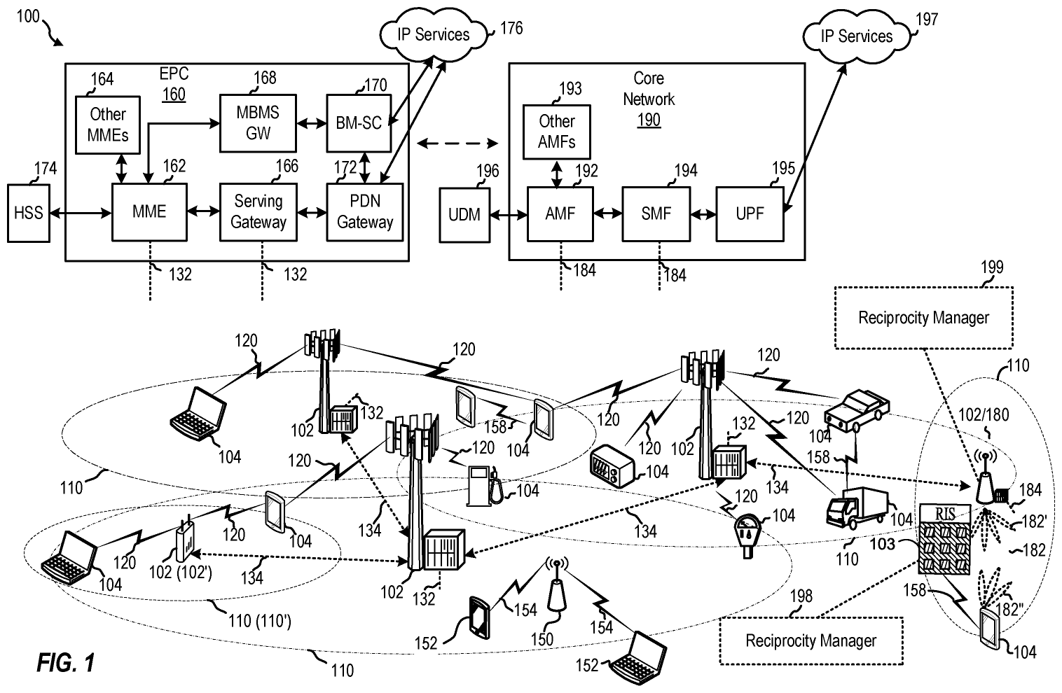

FIG. 1 depicts an example of a wireless communications network 100, in which aspects described herein may be implemented. Wireless communication network 100 may be a new radio (NR) network (e.g., a 5G NR network).

Generally, wireless communications network 100 includes base stations (BSs) 102, user equipments (UEs) 104, an Evolved Packet Core (EPC) 160, and core network 190 (e.g., a 5G Core (5GC)), which interoperate to provide wireless communications services.

BSs 102 may provide an access point to EPC 160 and/or to core network 190 for a UE 104. BSs 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs 102 may include and/or be referred to as a next generation Node B (gNB), a Node B, an evolved Node B (eNB), an access point (AP), a base transceiver station (BTS), a radio base station, a radio transceiver, a transceiver function, or a transmit reception point (TRP) in various contexts.

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BSs).

Communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. Communication links 120 may use MIMO antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal (MT), a wireless terminal, a remote terminal, a handset, a user agent, a mobile client, or a client.

In wireless communications, an electromagnetic spectrum is often subdivided, into various classes, bands, channels, or other features. The subdivision is often provided based on wavelength and frequency, where frequency may also be referred to as a carrier, a subcarrier, a frequency channel, a tone, or a subband.

In 5G, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is sometimes referred to (interchangeably) as a “millimeter wave” (“mmW” or “mmWave”) band in documents and articles, despite being different from the extremely high frequency (EHF) band (30 GHz-300 GHz), which is identified by the International Telecommunications Union (ITU) as a “millimeter wave” band because wavelengths at these frequencies are between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Communications using the mmWave or near mmWave radio frequency band (e.g., 3 GHz-300 GHz) may have higher path loss and a shorter range compared to lower frequency communications. Accordingly, in FIG. 1, a BS 102/180 can utilize beamforming 182 with UE 104 to compensate for path loss and increase range. To do so, BS 102/180 and the UE 104 may each include a plurality of antennas, such as antenna elements, antenna panels, and/or antenna arrays to facilitate the beamforming.

With beamforming, BS 102/180 can transmit a beamformed signal to UE 104 in one or more transmit directions 182′. UE 104 can receive the beamformed signal from the BS 102/180 in one or more receive directions 182″. UE 104 may also transmit a beamformed signal to BS 102/180 in one or more transmit directions 182″. BS 102/180 may receive the beamformed signal from UE 104 in one or more receive directions 182′. BS 102/180 and UE 104 can perform beam training to determine the best receive and transmit directions for each of BS 102/180 and UE 104. Notably, the transmit and receive directions for BS 102/180 may or may not be the same. Similarly, the transmit and receive directions for UE 104 may or may not be the same.

According to certain aspects, BSs 102 and UEs 104 may be configured for P-MIMO. As shown in FIG. 1, wireless communication network 100 includes one or more reconfigurable intelligent surfaces 103 that relay uplink and downlink transmissions between a BS 102/180 and UE 104. As shown, BS 102/180 includes a reciprocity manager 199 that is configured to signal RIS 103 to apply a first voltage set to one or more unit cells of RIS 103 for an uplink transmission and to apply a second voltage set to the one or more unit of RIS 103 for a downlink transmission, in accordance with aspects of the present disclosure. RIS 103 includes a reciprocity manager 198 that is configured to apply different voltages for uplink and downlink transmissions to provide a fixed reciprocity for P-MIMO, in accordance with aspects of the present disclosure.

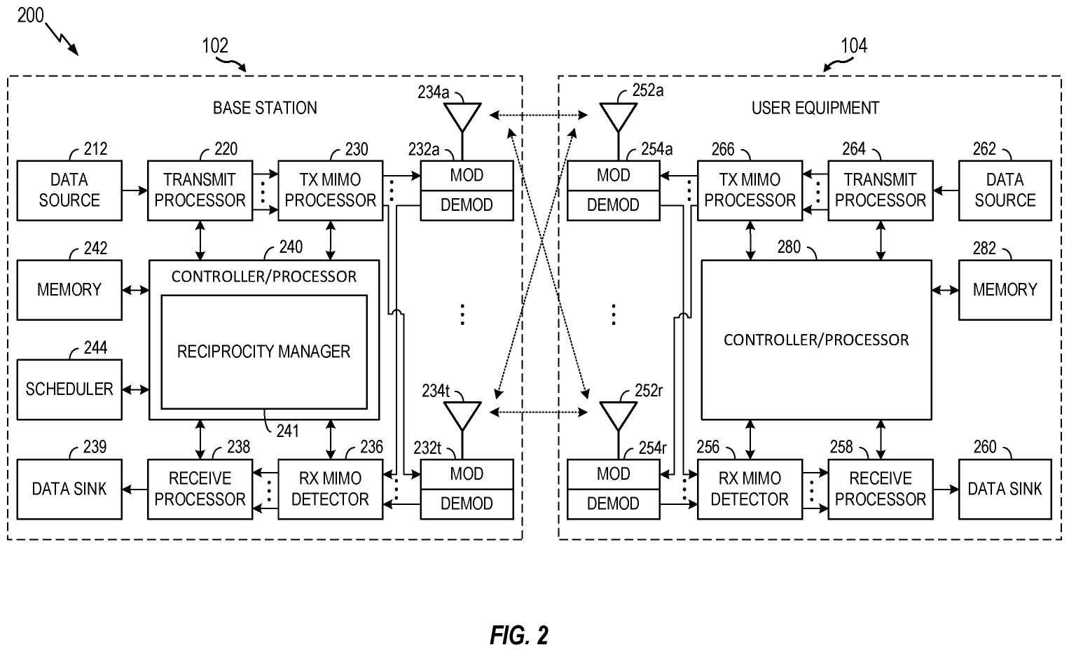

FIG. 2 depicts aspects of an example BS 102 and UE 104.

Generally, BS 102 includes various processors (e.g., 220, 230, 236m 238, and 240), antennas 234a-234t (collectively antennas 234), transceivers 232a-232t (collectively transceivers 232) which include modulators (MOD) and demodulators (DEMOD), and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes reciprocity manager 241, which may be representative of reciprocity manager 199 of FIG. 1. Notably, while depicted as an aspect of controller/processor 240, reciprocity manager 241 may be implemented additionally or alternatively in various other aspects of BS 102 in other implementations.

Generally, UE 104 includes various processors (e.g., 256, 258, 264, 266, and 280), antennas 252a-252r (collectively antennas 252), transceivers 254a-254r (collectively transceivers 254), which include modulators and demodulators, and other aspects, which enable wireless transmission of data (e.g., data source 262) and wireless reception of data (e.g., data sink 260).

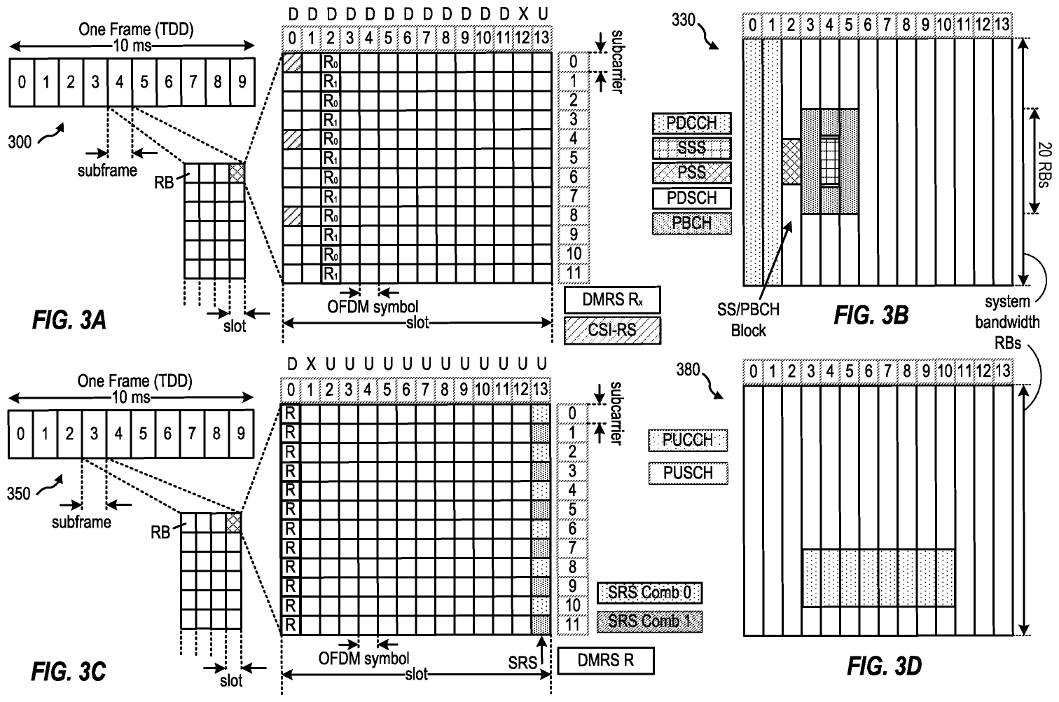

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe. Further discussions regarding FIG. 1, FIG. 2, and FIGS. 3A-3D are provided later in this disclosure.

### Example Passive MIMO

Multiple-input multiple-output (MIMO) technology increases throughput in wireless communications. MIMO can achieve high beamforming gain by using active antenna units and can operate with individual radio frequency (RF) chains for each antenna port. With MIMO antenna technology and spatial processing. A communication device may attempt to increase throughput by employing active antenna units (AAU) to increase a beamforming gain of the antenna elements of the communication device. The communication device may use AAU to focus transmitted energy into a spatially-filtered Tx beam directed towards another communication device.

To further such advantages and extend coverage, reconfigurable intelligent surface (RISs) may be deployed to reflect impinging waves in desired directions. In general, RISs enhance the coverage and capacity of wireless communication systems with low hardware cost and energy consumption. In some cases, RISs may operate without substantial power consumption when they operate passively to only reflect or refract beams from a transmitter towards a receiver. A receive may be passive, in that in lieu of using AAUs, a RIS can act as a mirror to reflect signals. In some cases, the reflection or refraction direction may be controlled by a network entity (e.g., base station (BS), next generation NodeB (gNB or gNodeB)) or a monitoring sidelink user equipment (UE).

RIS 103 may include a passive surface that may be dynamically configured to manipulate incident electromagnetic waves to change channel conditions. That is, RIS 103 may be a passive device that may be configured to reflect impinging waves in a certain direction without injecting additional power to the reflected waves. A BS 102/180 may configure RIS 103 to control the reflection direction of waves transmitted to RIS 103.

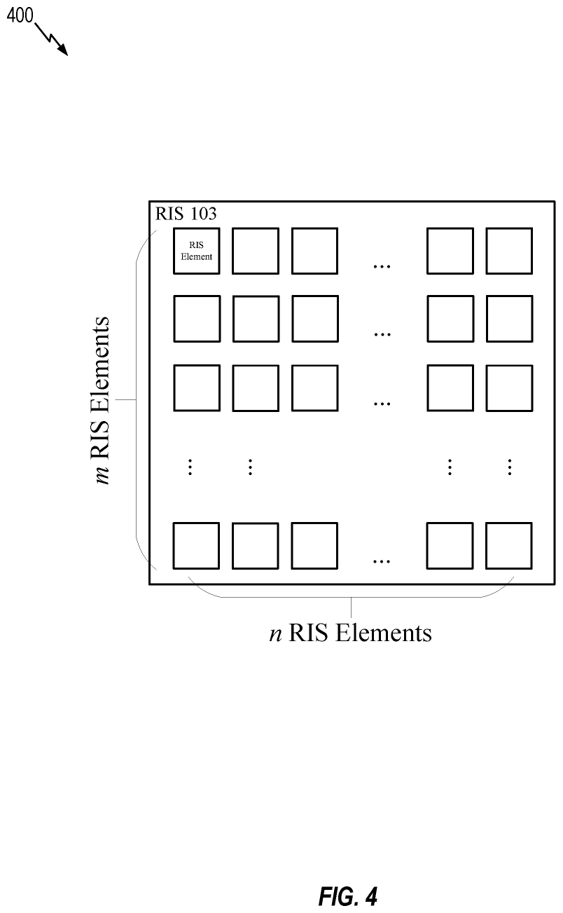

FIG. 4 illustrates an example arrangement 400 of RIS elements, in accordance with certain aspects of the present disclosure. As illustrated in FIG. 4, the surface of RIS 103 consists of any array of discrete elements, such as an m×n rectangular matrix of discrete elements, that can be controlled individually or on a group level. In some examples, such elements or group of elements may be referred to as a unit cell. Such elements may enable RIS 103 to perform passive beamforming. For example, RIS 103 may receive signal power from a transmitter (e.g., BS a 102 or a UE 104) proportional to the number of RIS elements thereon. When RIS 103 reflects or refracts the radio signal, elements of RIS 103 cause phase shifts to perform conventional beamforming or beamformer. The phase shifts are controlled by beamformer weights (e.g., a multiplier or an offset of time delay) applied to the elements of RIS 103. In some cases, for the arrangement 400 of RIS elements illustrated in FIG. 4, a respective beamformer weight may be generated or specified for each of the RIS elements by the RIS controller.

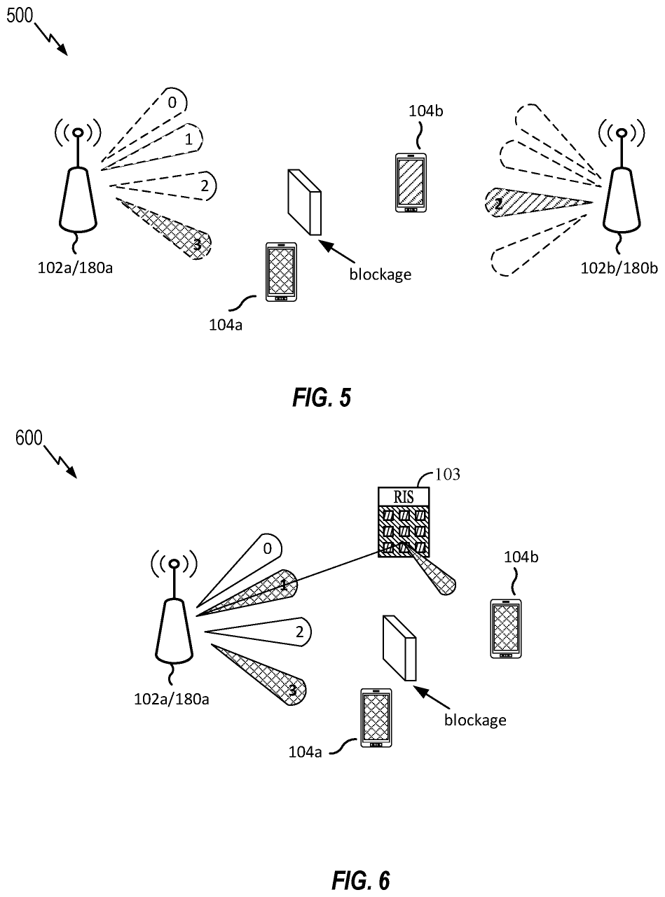

FIG. 5 illustrates an example wireless communication environment 500 in which signaling between a BS 102 and a UE 104 is blocked, in accordance with certain aspects of the present disclosure. As shown, a blockage (e.g., artificial blockages such as buildings, bridges, etc. or natural blockages such as terrains, mountains, changes in elevation, etc.) impedes a network entity, BS 102a/180a from being able to communicate with certain UEs.

The use of AAU and beamforming techniques may not be sufficient to provide service to all of the user equipment (e.g., UEs 104) in a coverage area of a base station (e.g., BS 102a/180a). As shown, BS 102a/180a can transmit to UE 104a, however, transmissions may not reach a second UE, UE 104b, such as due to the blockage. The blockage may also prevent UE 104a and UE 104b from establishing sidelink communications and, as such, UE 104b is prevented from communicating with BS 102a/180a via UE 104a using sidelink.

As shown in example wireless communication environment 500, in cases of a blockage, an operator may install a second BS 102b/180b (e.g., relay BS, macro BS, femto BS, or pico BS) to provide service coverage to a region experiencing the blockage (i.e., coverage hole). The second BS 102b/180b may communicate with and provide service to the blocked UE 104b. However, such an approach may add complexity to the wireless communication system and increase costs due to the duplication of active communication equipment. Furthermore, adding a base station to the wireless communication system may increase power consumption requirements of the wireless communication system.

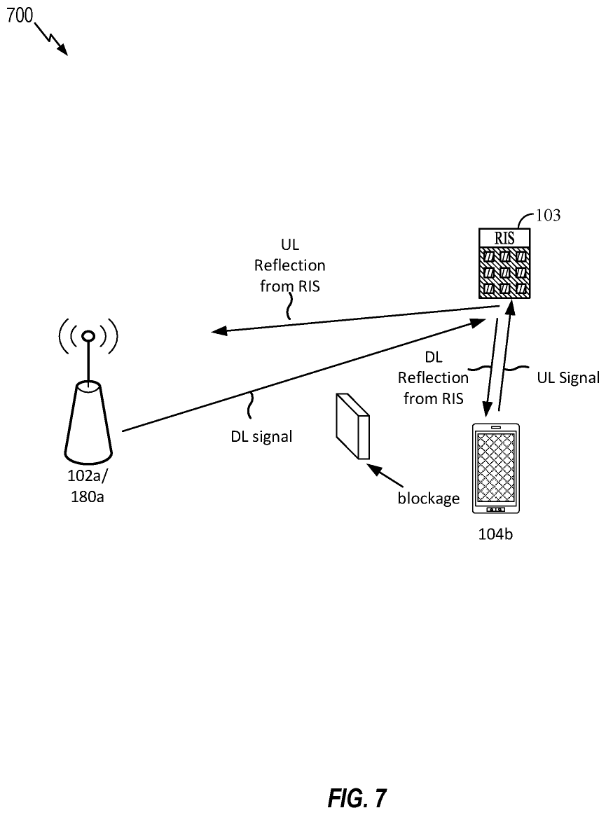

As shown in example wireless communication environment 600 in FIG. 6, a RIS 103 can be installed in wireless communication environment 600, for example, instead of adding a second BS 102b/180b. As shown, RIS 103 is introduced in wireless communication environment 600 to reflect, refract, or otherwise re-radiate, radio signals to bypass the blockage. For example, two-way communications between BS 102a/180a and UE 104b are enabled by RIS 103 re-radiating one or more beams from BS 102a/180a toward UE 104b, and vice versa. Furthermore, in some cases (not shown), RIS 103 can be reconfigured, such as with different beamformer values, to enable UEs 104a and 104b to establish sidelink communications.

In certain systems, the same beam that works in the downlink (e.g., a downlink signal using the beam is successfully received) is assumed to work for the uplink. For example, for initial access a BS 102a/180a transmits synchronization signal blocks (SSBs) in different directions using different beams and a UE 104 that receives a SSB with a particular beam responds in a random access channel (RACH) using the transmit beam corresponding to the receive beam of the received SSB. This may be referred to as beam correspondence, however, as discussed herein, beam correspondence may not hold when a RIS is used.

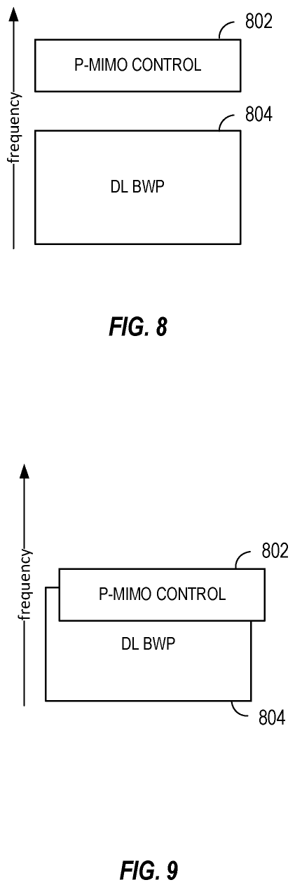

FIG. 7 illustrates a loss of reciprocity in an example wireless communication environment 700 between uplink and downlink signals relayed by a RIS 103, in accordance with certain aspects of the present disclosure.

As shown in FIG. 7, BS 102a/180a may transmit a downlink signal on a Tx beam in a direction associated with RIS 103. RIS 103 may reflect the downlink signal toward UE 104b and UE 104b may receive the downlink signal with an Rx beam of the UE. UE 104b may an uplink signal toward RIS 103 on a Tx beam corresponding to the Rx beam on which UE 104b received the downlink signal. RIS 103, however, may re-radiate signals differently in the uplink direction than in the downlink direction. For example, RIS 103 may have a different relationship between the impinging angle and the reflecting angle in the uplink direction and the downlink direction. Accordingly, there may not be reciprocity between the directions of uplink and downlink signals reflected by RIS 103. Thus, as shown in FIG. 7, the uplink signal, transmitted by UE 104b, may be reflected from RIS 103 in a direction such that BS 102a/180a may not be able to receive the uplink signal on the Rx beam that corresponds to the Tx beam used by BS 102a/180a to transmit the downlink signal.

Beam correspondence may maintained between a BS 102 and a UE 104. That is, the UE may transmit an uplink communication on a Tx beam that corresponds to the Rx beam on which a downlink signal is received by the UE, and the BS 102 may receive the uplink signal on an Rx beam that corresponds to the Tx beam on which the downlink signal was transmitted. As shown in FIG. 7, however, beam correspondence may not hold in an RIS-assisted procedure. Accordingly, a base station may not receive signals reflected by an RIS, or vice versa. Thus, network coverage using a RIS may be reduced, which may result in increased power consumption and network complexity associated with additional base stations or relay devices.

Accordingly, what is needed are techniques and apparatus for P-MIMO.

### Example Reciprocity for Passive MIMO

Aspects of the present disclosure provide techniques and apparatus for passive multiple-input multiple-output (P-MIMO) and more specifically, for a fixed reciprocity for P-MIMO. Aspects may provide for additional control by a network of a reconfigurable intelligent surface (RIS), such as a RIS 103 in wireless communication network 100. In some examples, a RIS 103 is configured to apply a first voltage set to provide a first angle of reflection for downlink signals and to apply a second voltage set, different than the first voltage set, to provide a second angle of reflection for uplink signals. The voltages may be selected and applied such that beam correspondence and reciprocity holds signals in the uplink direction and the downlink direction.

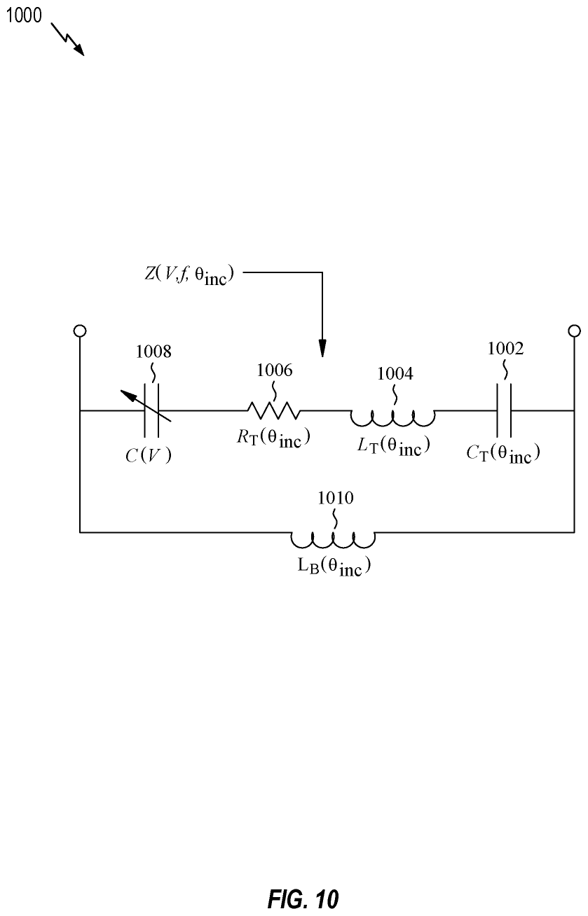

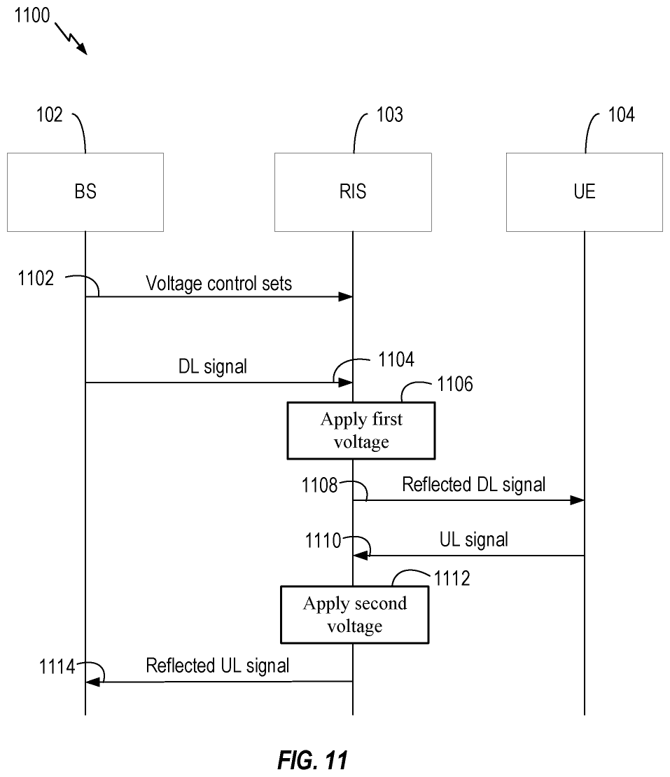

As mentioned above, a RIS 103 may be controlled by the network. The control may be wired or wireless (via an air interface). For both wired and wireless solutions, RIS 103 may include a processor to process control information from the network. For wireless control, RIS 103 may further include at least one antenna or receive chain. For wireless control, a sequence-based control channel may be used or a control channel similar to the physical downlink control channel (PDCCH) may be used. The P-MIMO control channel 802 may be transmitted in dedicated resources independent from the downlink bandwidth part (BWP) 804, as shown in FIG. 8 or in frequency resources overlapping, partially or fully, with the DL BWP 804 as shown in FIG. 9. The scrambling sequence for P-MIMO control channel 802 may depend on a physical cell identifier (PCI) of the network entity (e.g., a gNB) transmitting P-MIMO control channel 802 and/or a P-MIMO ID (e.g., an identifier of RIS 103). The resources for P-MIMO control channel 802 can indicated to the UE 104 receiving P-MIMO control channel 802. RIS 103 can perform time and frequency tracking based on P-MIMO control channel 802.

Reflection of signals by RIS 103 can be controlled based on voltage sets applied to unit cells of RIS 103. A reflection coefficient, F, represents a phase difference between the incoming beam and the reflected beam. The reflection coefficient, Γ, may be based on initial impedance, Z₀, and impedance, Z, that is dependent on the frequency, f of the signal coming in to RIS 103, the angle of incidence, θ_{inc}, of the signal, and the voltage, V, applied to the unit cell. The voltage, V, may be a tunable reverse bias voltage applied to a varactor of the RIS. In an example, the reflection coefficient may be given by the following formula:

$$Γ = \frac{Z ( V , f , {θ}_{i n c} ) - {Z}_{0}}{Z ( V , f , {θ}_{i n c} ) + {Z}_{0}}$$

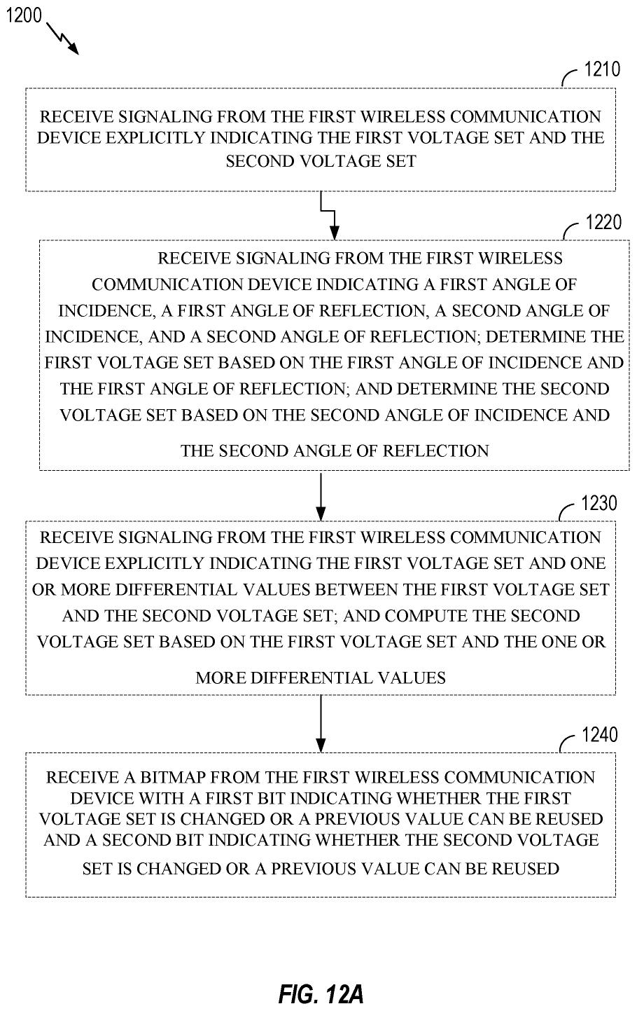

FIG. 10 is an example varactor circuit 1000 in a RIS, in accordance with certain aspects of the present disclosure. As shown, varactor circuit 1000 includes a capacitor 1002, an inductor 1004, a resistor 1006, and a variable capacitor 1008 coupled in parallel to another inductor 1010.

Ideally, the reflection coefficient, F, is the same for uplink and downlink in order to achieve reciprocity and beam correspondence. However, because the angle of incidence, θ_{inc}, is different for uplink and downlink, the reflection coefficient, Γ, will be different if the same voltage, V, is applied. Thus, to reflect a signal in a desired direction, θ_{ref} (e.g., to achieve the same reflection coefficient, Γ, for uplink and downlink) an appropriate voltage for an nth RIS element (e.g., unit cell), vₙ, can be selected. Accordingly, the angle of reflection, θ_{ref}, depends on the angle of incidence, Bine, frequency, f and selected voltage for an nth RIS element, vₙ. For a unit cell, n, an nth entry in a steering vector, aₙ, applied to a signal x, the output signal can be represented as:

$$x \cdot {Σ}_{n} {a}_{n} ( {θ}_{i n c} ) \cdot Γ ( {V}_{n} , f , {θ}_{i n c} ) \cdot {a}_{n} ( {θ}_{r e f} ) .$$

RIS 103 may be aware of when it is reflecting in the uplink and when it is reflecting in the downlink. In some examples, BS 102a/180a provides RIS 103 with information, such as a schedule, regarding uplink and downlink transmissions. BS 102a/180a may provide RIS 103 with the information in P-MIMO control channel 802.

RIS 103 may be provided with a pair of control voltage sets, {Vₙ^{(DL)}} for downlink or θ_{inc}→θ_{ref}, and {Vₙ^{(UL)}} for uplink or θ_{ref}→θ_{inc}. According to certain aspects, the pair of control voltage sets is explicitly signaled over the P-MIMO control interface. For example, a BS 102 explicitly signals the voltage sets to RIS 103 in P-MIMO control channel 802 indicating the voltage to apply for uplink and the voltage to apply for downlink.

Alternatively, RIS 103 may be configured with a look-up table (LUT). RIS 103 can determine the voltages to apply using the LUT. For example, the LUT may contain tuples of [θ_{inc},θ_{ref}, V]. Thus, by looking up the pair of angle of incidence and angle reflection for a signal, RIS 103 can select the corresponding voltage (or voltage set) to apply. In some examples, a BS 102 can signal (θ_{inc},θ_{ref}) to RIS 103 and then, RIS 103 selects the voltage(s) based on the received control message.

According to certain aspects, RIS 103 can be explicitly signaled one control voltage set (e.g., for DL) and the other control set (e.g., for UL) is signaled as one or more differentials (e.g., a deltas) with respect to the first control voltage set. Accordingly, RIS 103 can derive the second control voltage set from first control voltage set and the signaled delta.

According to certain aspects, RIS 103 can be signaled a bitmap. The bitmap may include bits mapping to control voltage sets. The bitmap may include a bit to indicate for each control voltage set that indicates whether the voltages are the same or unchanged. For example, if same/unchanged (e.g., bit is 0), no explicit voltage set is transmitted and RIS 103 can use the previous corresponding value. If the voltage is changed, then further information can be sent later indicating the changed control voltage set using any of the signaling approaches discussed herein.

According to certain aspects, a 1-bit differential indication is used. RIS 103 maintains a set of control voltage pairs for DL and another set of control voltage pairs for UL. The network can signal an index to a pair in a set control voltage pairs (e.g., for DL). RIS 103 can look up the index to find the corresponding pair and apply it. For the other set of control voltage pairs (e.g., for UL), the network can signal a 1-bit indication to indicate whether the index pointing to a pair in the first set is also used for the lookup in the second set.

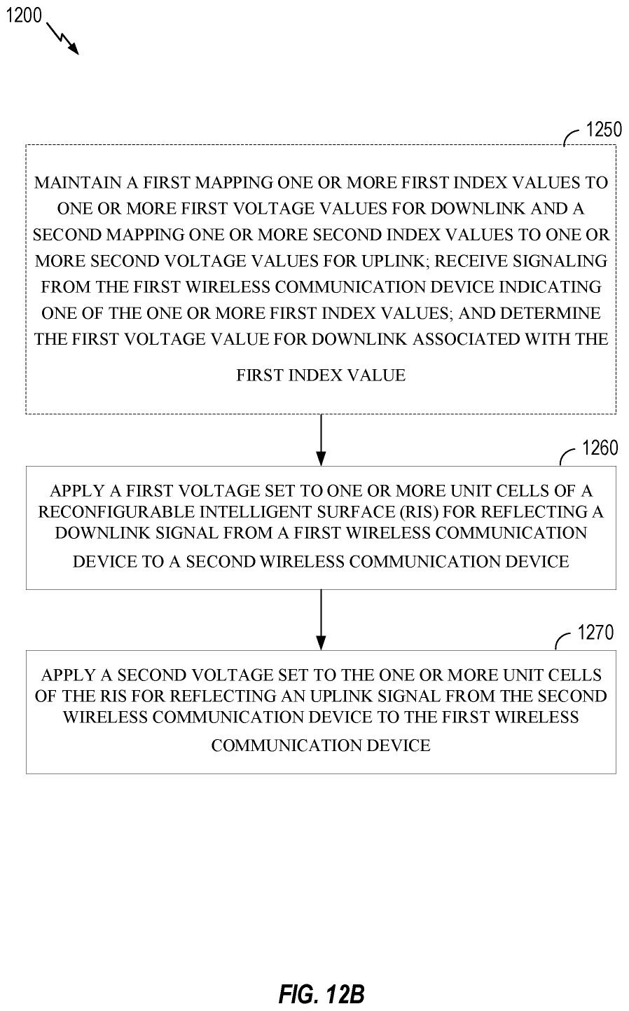

FIG. 11 is a call flow diagram illustrating example signaling 1100 for fixed reciprocity P-MIMO, in accordance with aspects of the present disclosure. As shown, a RIS 103 reflects signals between a BS 102 and UE 104. At 1102, BS 102 configures RIS 103 with control voltage sets for uplink and downlink. At 1104, BS 102 transmits a downlink signal to RIS 103 for UE 104. At 1106, RIS 103 applies a first voltage set to one or more unit cells of RIS 103 and, at 1108, reflects the downlink signal to UE 104. At 1110, UE 1104 transmits an uplink signal to RIS 103 for BS 102. At 1112, RIS 103 applies a second voltage set to the one or more units cells and, at 1114, reflects the uplink signal to BS 102.

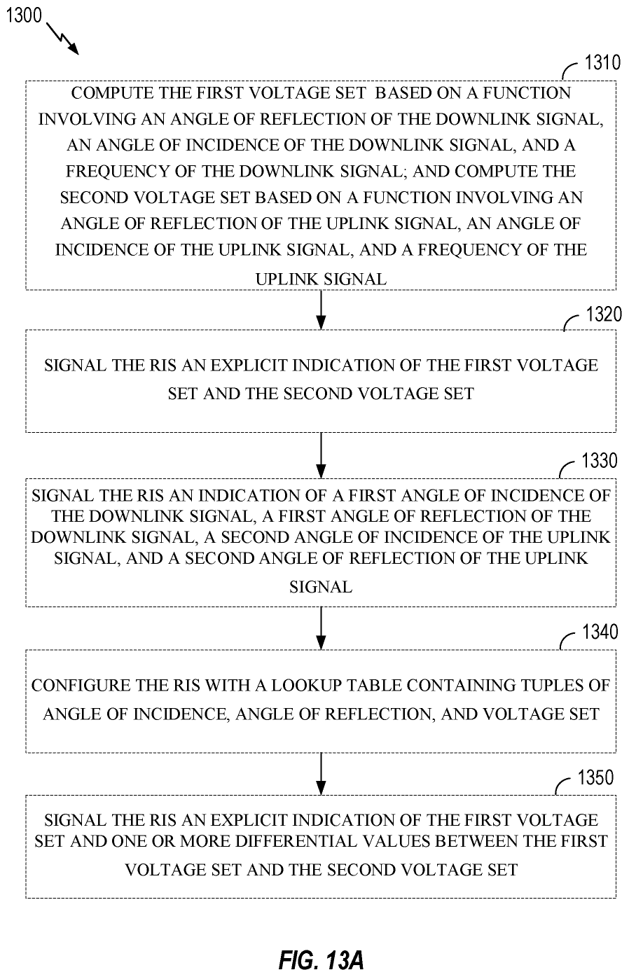

FIG. 12A-12B is a flow diagram illustrating example operations 1200 for wireless communication, in accordance with certain aspects of the present disclosure. Operations 1200 may be performed, for example, by a RIS (such as a RIS 103 in the wireless communication network 100).

At block 1210, the RIS may receive signaling from a first wireless communication device explicitly indicating a first voltage set and a second voltage set. The first wireless communication device may be a BS (e.g., a gNB). The first voltage set may be for uplink and the second voltage may be for downlink. A voltage set may include a plurality of voltages for applying to a plurality of unit cells of the RIS.

At block 1220, the RIS may receive signaling from the first wireless communication device indicating a first angle of incidence, a first angle of reflection, a second angle of incidence, and a second angle of reflection. The RIS may determine the first voltage set based on the first angle of incidence and the first angle of reflection. The RIS may determine the second voltage set based on the second angle of incidence and the second angle of reflection. In some examples, the RIS identifies a first one or more tuples in a lookup table. The first one or more tuples contains the first angle of incidence, the first angle of reflection, and the first voltage set. The RIS identifies a second one or more tuples in a lookup table. The second one or more tuples containing the second angle of incidence, the second angle of reflection, and the second voltage set.

At block 1230, the RIS may receive signaling from the first wireless communication device explicitly indicating the first voltage set and one or more differential values between the first voltage set and the second voltage set. The RIS computes the second voltage set based on the first voltage set and the one or more differential values.

At block 1240, the RIS may receive a bitmap from the first wireless communication device with a first bit indicating whether the first voltage set is changed or a previous value can be reused and a second bit indicating whether the second voltage set is changed or a previous value can be reused.

At block 1250, the RIS maintains a first mapping one or more first index values to one or more first voltage values for downlink and a second mapping one or more second index values to one or more second voltage values for uplink. The RIS may receive signaling from the first wireless communication device indicating one of the one or more first index values. The RIS may determine the first voltage value for downlink associated with the first index value. The RIS may receive signaling from the first wireless communication device indicating to use the first index value for the second mapping for uplink.

At block 1260, the RIS applies a first voltage set to one or more unit cells of the RIS for reflecting a downlink signal from a first wireless communication device to a second wireless communication device.

At block 1270, the RIS applies a second voltage set to the one or more unit cells of the RIS for reflecting an uplink signal from the second wireless communication device to the first wireless communication device.

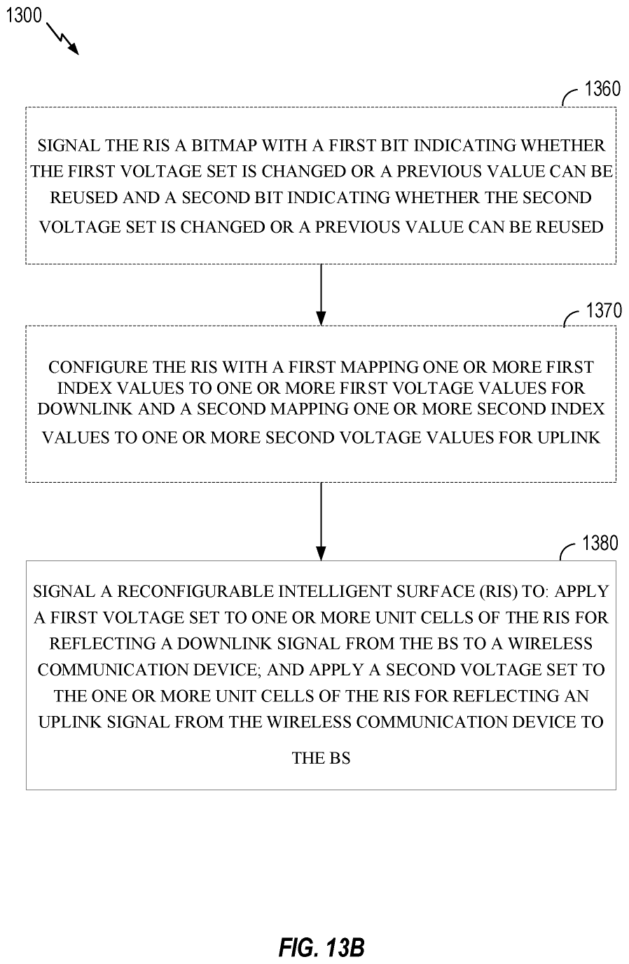

FIG. 13A-13B is a flow diagram illustrating example operations 1300 for wireless communication, in accordance with certain aspects of the present disclosure. Operations 1300 may be performed, for example, by a BS (such as a BS 102 in the wireless communication network 100). Operations 1300 may be complementary to the operations 1200 performed by the RIS. The operations 1300 may be implemented as software components that are executed and run on one or more processors (e.g., controller/processor 240 of FIG. 2). Further, the transmission and reception of signals by the BS in operations 1300 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 1300 may begin, at block 1310, by computing a first voltage set based on a function involving an angle of reflection of the downlink signal, an angle of incidence of the downlink signal, and a frequency of the downlink signal. The BS computes a second voltage set based on a function involving an angle of reflection of the uplink signal, an angle of incidence of the uplink signal, and a frequency of the uplink signal.

At 1320, the BS may signal to a RIS an explicit indication of the first voltage set and the second voltage set.

At 1330, the BS may signal to the RIS an indication of a first angle of incidence of the downlink signal, a first angle of reflection of the downlink signal, a second angle of incidence of the uplink signal, and a second angle of reflection of the uplink signal.

At 1340, the BS may configure the RIS with a lookup table containing tuples of angle of incidence, angle of reflection, and voltage (or voltage set).

At 1350, the BS may signal to the RIS an explicit indication of the first voltage set and one or more differential values between the first voltage set and the second voltage set.

At 1360, the BS may signal to the RIS an indication of a bitmap with a first bit indicating whether the first voltage set is changed or a previous value can be reused and a second bit indicating whether the second voltage set is changed or a previous value can be reused.

At 1370, the BS may configure the RIS with a first mapping one or more first index values to one or more first voltage values for downlink and a second mapping one or more second index values to one or more second voltage values for uplink. The signaling to the RIS indicates one of the one or more first index values. The BS may signal the RIS to use the first index value for the second mapping for uplink.

At 1380, the RIS signals a RIS to: apply a first voltage set to one or more unit cells of the RIS for reflecting a downlink signal from the BS to a wireless communication device; and apply a second voltage set to the one or more unit cells of the RIS for reflecting an uplink signal from the wireless communication device to the BS.

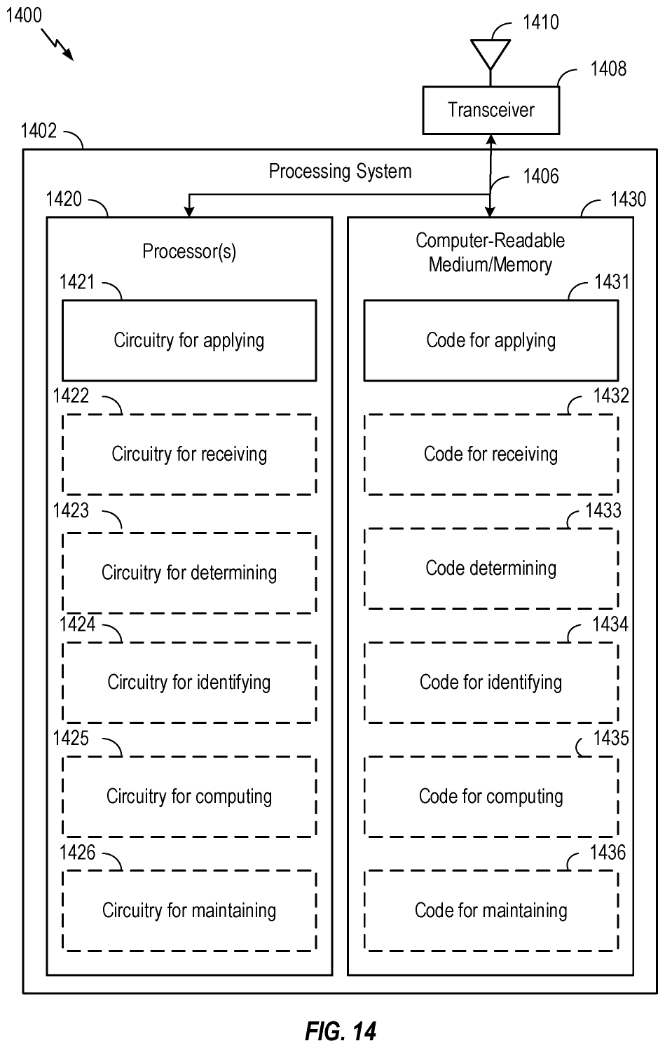

FIG. 14 illustrates a communications device 1400 that may include various components (e.g., corresponding to means-plus-function components) configured to perform operations for the techniques disclosed herein, such as the operations illustrated in FIG. 12A-12B. Communications device 1400 includes a processing system 1402. For a wireless control RIS, processing system 1402 is coupled to a transceiver 1408 (e.g., a transmitter and/or a receiver). Transceiver 1408 is configured to transmit and receive signals for communications device 1400 via an antenna 1410, such as the various signals as described herein. Processing system 1402 may be configured to perform processing functions for communications device 1400, including processing signals received and/or to be transmitted by communications device 1400.

Processing system 1402 includes processor(s) 1420 coupled to a computer-readable medium/memory 1430 via a bus 1406. In certain aspects, computer-readable medium/memory 1430 is configured to store instructions (e.g., computer-executable code) that when executed by processor(s) 1420, cause processor(s) 1420 to perform the operations illustrated in FIG. 12A-12B, or other operations for performing the various techniques discussed herein for fixed reciprocity in P-MIMO. In certain aspects, computer-readable medium/memory 1430 stores code 1431 for applying; code 1432 for receiving; code 1433 for determining; code 1434 for identifying; code 1435 for computing; and/or code 1436 for maintaining. In certain aspects, processor(s) 1420 has circuitry configured to implement the code stored in computer-readable medium/memory 1430. Processor(s) 1420 includes circuitry 1421 for applying; circuitry 1422 for receiving; circuitry 1423 for determining; circuitry 1424 for identifying; circuitry 1425 for computing; and/or circuitry 1426 for maintaining.

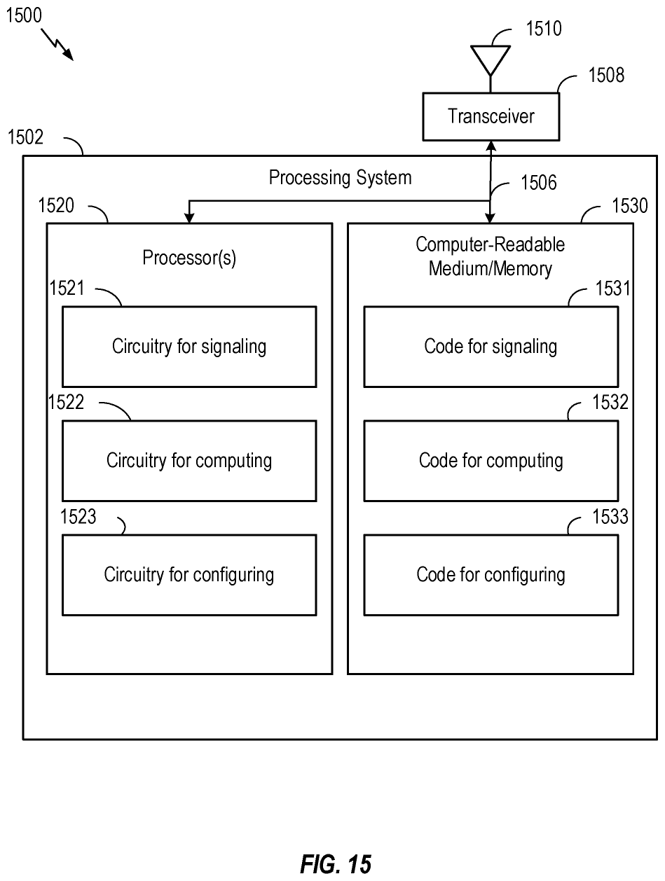

FIG. 15 illustrates a communications device 1500 that may include various components (e.g., corresponding to means-plus-function components) configured to perform operations for the techniques disclosed herein, such as the operations illustrated in FIG. 13A-13B. Communications device 1500 includes a processing system 1502 coupled to a transceiver 1508 (e.g., a transmitter and/or a receiver). Transceiver 1508 is configured to transmit and receive signals for communications device 1500 via an antenna 1510, such as the various signals as described herein. Processing system 1502 may be configured to perform processing functions for communications device 1500, including processing signals received and/or to be transmitted by communications device 1500.

Processing system 1502 includes processor(s) 1520 coupled to a computer-readable medium/memory 1530 via a bus 1506. In certain aspects, computer-readable medium/memory 1530 is configured to store instructions (e.g., computer-executable code) that when executed by processor(s) 1520, cause processor(s) 1520 to perform the operations illustrated in FIG. 13A-13B, or other operations for performing the various techniques discussed herein for fixed reciprocity in P-MIMO. In certain aspects, computer-readable medium/memory 1530 stores code 1531 for signaling; code 1532 for computing; and/or code 1533 for configuring. In certain aspects, processor(s) 1520 has circuitry configured to implement the code stored in computer-readable medium/memory 1530. Processor(s) 1520 includes circuitry 1521 for signaling; circuitry 1522 for computing; and/or circuitry 1523 for configuring.

Aspects described herein provide a technical solution to a technical problem. By applying different voltages for uplink and downlink communications, fixed reciprocity may hold for P-MIMO. Thus, a transmitter and receiver can select the corresponding beams to be used for transmitting and receiving and the RIS will reflect the signals such that the signals can be received in both uplink and downlink. Thus, benefits of using a RIS to improve network coverage, with low overhead, can be achieved while still ensuring fixed reciprocity.

### Example Aspects

In addition to the various aspects described above, the aspects can be combined. Some specific combinations of aspects are detailed below:

Aspect 1. A method for wireless communication by a reconfigurable intelligent surface (RIS), comprising: applying a first voltage set to one or more unit cells of the RIS for reflecting a downlink signal from a first wireless communication device to a second wireless communication device; and applying a second voltage set to the one or more unit cells of the RIS for reflecting an uplink signal from the second wireless communication device to the first wireless communication device.

Aspect 2. The method of aspect 1, further comprising: receiving signaling from the first wireless communication device explicitly indicating the first voltage set and the second voltage set.

Aspect 3. The method of any of aspects 1-2, further comprising: receiving signaling from the first wireless communication device indicating a first angle of incidence, a first angle of reflection, a second angle of incidence, and a second angle of reflection; determining the first voltage set based on the first angle of incidence and the first angle of reflection; and determining the second voltage set based on the second angle of incidence and the second angle of reflection.

Aspect 4. The method of any of aspects 1-3, wherein: determining the first voltage based on the first angle of incidence and the first angle of reflection comprises identifying a first one or more tuples in a lookup table, the first one or more tuples containing the first angle of incidence, the first angle of reflection, and the first voltage set; and determining the second voltage set based on the second angle of incidence and the second angle of reflection comprises identifying a second one or more tuples in a lookup table, the second one or more tuples containing the second angle of incidence, the second angle of reflection, and the second voltage set.

Aspect 5. The method of any of aspects 1-4, further comprising: receiving signaling from the first wireless communication device explicitly indicating the first voltage set and one or more differential values between the first voltage set and the second voltage set; and computing the second voltage set based on the first voltage and the one or more differential values.

Aspect 6. The method of any of aspects 1-5, further comprising: receiving a bitmap from the first wireless communication device with a first bit indicating whether the first voltage set is changed or a previous value can be reused and a second bit indicating whether the second voltage set is changed or a previous value can be reused.

Aspect 7. The method of any of aspects 1-6, further comprising: maintaining a first mapping one or more first index values to one or more first voltage values for downlink and a second mapping one or more second index values to one or more second voltage values for uplink; receiving signaling from the first wireless communication device indicating one of the one or more first index values; and determining the first voltage value for downlink associated with the first index value.

Aspect 8. The method of aspect 7, further comprising: receiving signaling from the first wireless communication device indicating to use the first index value for the second mapping for uplink.

Aspect 9. A method for wireless communication by a base station (BS), comprising signaling a reconfigurable intelligent surface (RIS) to: apply a first voltage set to one or more unit cells of the RIS for reflecting a downlink signal from the BS to a wireless communication device; and apply a second voltage set to the one or more unit cells of the RIS for reflecting an uplink signal from the wireless communication device to the BS.

Aspect 10. The method of aspect 9, further comprising: computing the first voltage set based on a function involving an angle of reflection of the downlink signal, an angle of incidence of the downlink signal, and a frequency of the downlink signal; and computing the second voltage set based on a function involving an angle of reflection of the uplink signal, an angle of incidence of the uplink signal, and a frequency of the uplink signal.

Aspect 11. The method of any of aspects 9-10, wherein the signaling to the RIS explicitly indicates the first voltage set and the second voltage set.

Aspect 12. The method of any of aspects 9-11, wherein the signaling to the RIS indicates a first angle of incidence of the downlink signal, a first angle of reflection of the downlink signal, a second angle of incidence of the uplink signal, and a second angle of reflection of the uplink signal.

Aspect 13. The method of aspect 12 further comprising configuring the RIS with a lookup table containing tuples of angle of incidence, angle of reflection, and voltage.

Aspect 14. The method of any of aspects 9-13, wherein the signaling to the RIS explicitly indicates the first voltage set and one or more differential values between the first voltage set and the second voltage set.

Aspect 15. The method of any of aspects 9-14, wherein the signaling to the RIS indicates a bitmap with a first bit indicating whether the first voltage set is changed or a previous value can be reused and a second bit indicating whether the second voltage set is changed or a previous value can be reused.

Aspect 16. The method of any of aspects 9-15, further comprising configuring the RIS with a first mapping one or more first index values to one or more first voltage values for downlink and a second mapping one or more second index values to one or more second voltage values for uplink, wherein the signaling to the RIS indicates one of the one or more first index values.

Aspect 17. The method of aspect 16, further comprising: signaling the RIS to use the first index value for the second mapping for uplink.

Aspect 18. An apparatus comprising means for performing the method of any of aspects 1 through 17.

Aspect 19. An apparatus comprising at least one processor and a memory coupled to the at least one processor, the memory comprising code executable by the at least one processor to cause the apparatus to perform the method of any of aspects 1 through 17.

Aspect 20. A computer readable medium storing computer executable code thereon for wireless communications that, when executed by at least one processor, cause an apparatus to perform the method of any of aspects 1 through 17.

### Additional Wireless Communication Network Aspects

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements. In addition, these service may co-exist in the same subframe.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS or a home BS.

BS 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with core network 190 through second backhaul links 184. BSs 102 may communicate directly or indirectly (e.g., through EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some BSs, such as BS 180 may operate in a traditional sub-6 GHz spectrum, in millimeter wave (mmWave) frequencies, and/or near mmWave frequencies in communication with the UE 104. When BS 180 operates in mmWave or near mmWave frequencies, BS 180 may be referred to as an mmWave BS.

Communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers (CCs) may include a primary component carrier (PCC) and one or more secondary component carriers (SCCs). A PCC may be referred to as a primary cell (PCell) and a SCC may be referred to as a secondary cell (SCell).

Wireless communications network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the PUSCH) from a data source 262 and control information (e.g., for the physical uplink control channel (PUCCH) from controller/processor 280. Transmit processor 264 may also generate reference symbols for a reference signal (e.g., for the sounding reference signal (SRS)). The symbols from transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-234t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be TDD, in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing (SCS) and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of reciprocity in passive multiple-input multiple-output (P-MIMO) in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 10-12B.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. An apparatus for wireless communication, comprising:
at least one processor; and
a memory coupled to the at least one processor, the memory comprising code executable by the at least one processor to cause the apparatus to:
apply a first voltage set to one or more unit cells of a reconfigurable intelligent surface (RIS) for reflecting a downlink signal from a first wireless communication device to a second wireless communication device; and
apply a second voltage set to the one or more unit cells of the RIS for reflecting an uplink signal from the second wireless communication device to the first wireless communication device.

2. The apparatus of claim 1, the code further executable by the at least one processor to cause the apparatus to:
receive signaling from the first wireless communication device explicitly indicating the first voltage set and the second voltage set.

3. The apparatus of claim 1, the code further executable by the at least one processor to cause the apparatus to:
receive signaling from the first wireless communication device indicating a first angle of incidence, a first angle of reflection, a second angle of incidence, and a second angle of reflection;
determine the first voltage set based on the first angle of incidence and the first angle of reflection; and
determine the second voltage set based on the second angle of incidence and the second angle of reflection.

4. The apparatus of claim 3, wherein the code executable by the at least one processor to cause the apparatus to determine the first voltage set based on the first angle of incidence and the first angle of reflection comprises code executable by the at least one processor to cause the apparatus to:
identify one or more first tuples in a lookup table, the one or more first tuples containing the first angle of incidence, the first angle of reflection, and the first voltage set; and
identify one or more second tuples in a lookup table, the one or more second tuples containing the second angle of incidence, the second angle of reflection, and the second voltage set.

5. The apparatus of claim 1, the code further executable by the at least one processor to cause the apparatus to:
receive signaling from the first wireless communication device explicitly indicating the first voltage set and one or more differential values between the first voltage set and the second voltage set; and
compute the second voltage set based on the first voltage set and the one or more differential values.

6. The apparatus of claim 1, the code further executable by the at least one processor to cause the apparatus to:
receive a bitmap from the first wireless communication device with a first bit indicating whether the first voltage set is changed or a previous value can be reused and a second bit indicating whether the second voltage set is changed or a previous value can be reused.

7. The apparatus of claim 1, the code further executable by the at least one processor to cause the apparatus to:
maintain a first mapping of one or more first index values to one or more first voltage values for downlink and a second mapping of one or more second index values to one or more second voltage values for uplink;
receive signaling from the first wireless communication device indicating one of the one or more first index values; and
determine the first voltage value for downlink associated with the first index value.

8. The apparatus of claim 7, the code further executable by the at least one processor to cause the apparatus to:
receive signaling from the first wireless communication device indicating to use the first index value for the second mapping for uplink.

9. The apparatus of claim 1, wherein the first voltage set comprises a first plurality of voltages applied to a plurality of unit cells and the second voltage set comprises a second plurality of voltages applied to the plurality of unit cells.

10. An apparatus for wireless communication, comprising:
at least one processor; and
a memory coupled to the at least one processor, the memory comprising code executable by the at least one processor to cause the apparatus to signal a reconfigurable intelligent surface (RIS) to:
apply a first voltage set to one or more unit cells of the RIS for reflecting a downlink signal from the BS to a wireless communication device; and
apply a second voltage set to the one or more unit cells of the RIS for reflecting an uplink signal from the wireless communication device to the BS.

11. The apparatus of claim 10, the code further executable by the at least one processor to cause the apparatus to:
compute the first voltage set based on a function involving an angle of reflection of the downlink signal, an angle of incidence of the downlink signal, and a frequency of the downlink signal; and
compute the second voltage set based on a function involving an angle of reflection of the uplink signal, an angle of incidence of the uplink signal, and a frequency of the uplink signal.

12. The apparatus of claim 10, wherein the code executable by the at least one processor to cause the apparatus to signal the RIS comprises code executable by the at least one processor to cause the apparatus to signal the RIS an explicit indication of the first voltage set and the second voltage set.

13. The apparatus of claim 10, wherein the code executable by the at least one processor to cause the apparatus to signal the RIS comprises code executable by the at least one processor to cause the apparatus to signal the RIS an indication of a first angle of incidence of the downlink signal, a first angle of reflection of the downlink signal, a second angle of incidence of the uplink signal, and a second angle of reflection of the uplink signal.

14. The apparatus of claim 13, the code further executable by the at least one processor to cause the apparatus to configure the RIS with one or more lookup tables containing tuples of angle of incidence, angle of reflection, and voltage.

15. The apparatus of claim 10, wherein the code executable by the at least one processor to cause the apparatus to signal the RIS comprises code executable by the at least one processor to cause the apparatus to signal the RIS an explicit indication of the first voltage set and one or more differential values between the first voltage set and the second voltage set.

16. The apparatus of claim 10, wherein the code executable by the at least one processor to cause the apparatus to signal the RIS comprises code executable by the at least one processor to cause the apparatus to signal the RIS a bitmap with a first bit indicating whether the first voltage set is changed or a previous value can be reused and a second bit indicating whether the second voltage set is changed or a previous value can be reused.

17. The apparatus of claim 10, the code further executable by the at least one processor to cause the apparatus to:
configure the RIS with a first mapping of one or more first index values to one or more first voltage values for downlink and a second mapping of one or more second index values to one or more second voltage values for uplink, wherein
the code executable by the at least one processor to cause the apparatus to signal the RIS comprises code executable by the at least one processor to cause the apparatus to signal the RIS an explicit indication one of the one or more first index values.

18. The apparatus of claim 17, the code further executable by the at least one processor to cause the apparatus to:
signal the RIS to use the first index value for the second mapping for uplink.

19. The apparatus of claim 10, wherein the first voltage set comprises a first plurality of voltages applied to a plurality of unit cells and the second voltage set comprises a second plurality of voltages applied to the plurality of unit cells.

20. A method for wireless communication by a reconfigurable intelligent surface (RIS), comprising:
applying a first voltage set to one or more unit cells of the RIS for reflecting a downlink signal from a first wireless communication device to a second wireless communication device; and
applying a second voltage set to the one or more unit cells of the RIS for reflecting an uplink signal from the second wireless communication device to the first wireless communication device.

21. The method of claim 20, further comprising:
receiving signaling from the first wireless communication device explicitly indicating the first voltage set and the second voltage set.

22. The method of claim 20, further comprising:
receiving signaling from the first wireless communication device indicating a first angle of incidence, a first angle of reflection, a second angle of incidence, and a second angle of reflection;
determining the first voltage set based on the first angle of incidence and the first angle of reflection; and
determining the second voltage set based on the second angle of incidence and the second angle of reflection.

23. The method of claim 22, wherein:
determining the first voltage set based on the first angle of incidence and the first angle of reflection comprises identifying one or more first tuples in a lookup table, the one or more first tuples containing the first angle of incidence, the first angle of reflection, and the first voltage set; and
determining the second voltage set based on the second angle of incidence and the second angle of reflection comprises identifying one or more second tuples in a lookup table, the one or more second tuples containing the second angle of incidence, the second angle of reflection, and the second voltage set.

24. The method of claim 20, further comprising:
receiving signaling from the first wireless communication device explicitly indicating the first voltage set and one or more differential values between the first voltage set and the second voltage set; and
computing the second voltage set based on the first voltage set and the one or more differential values.

25. The method of claim 20, further comprising:
receiving a bitmap from the first wireless communication device with a first bit indicating whether the first voltage set is changed or a previous value can be reused and a second bit indicating whether the second voltage set is changed or a previous value can be reused.

26. The method of claim 20, further comprising:
maintaining a first mapping of one or more first index values to one or more first voltage values for downlink and a second mapping of one or more second index values to one or more second voltage values for uplink;
receiving signaling from the first wireless communication device indicating one of the one or more first index values; and
determining the first voltage value for downlink associated with the first index value.

27. The method of claim 26, further comprising:
receiving signaling from the first wireless communication device indicating to use the first index value for the second mapping for uplink.

28. The method of claim 20, wherein the first voltage set comprises a first plurality of voltages applied to a plurality of unit cells and the second voltage set comprises a second plurality of voltages applied to the plurality of unit cells.

29. A method for wireless communication by a base station (BS), comprising:
signaling a reconfigurable intelligent surface (RIS) to:
apply a first voltage set to one or more unit cells of the RIS for reflecting a downlink signal from the BS to a wireless communication device; and
apply a second voltage set to the one or more unit cells of the RIS for reflecting an uplink signal from the wireless communication device to the BS.

30. The method of claim 26, further comprising:
computing the first voltage set based on a function involving an angle of reflection of the downlink signal, an angle of incidence of the downlink signal, and a frequency of the downlink signal; and
computing the second voltage set based on a function involving an angle of reflection of the uplink signal, an angle of incidence of the uplink signal, and a frequency of the uplink signal.
